(19) United States
(12) Patent Application Publication
(10) Pub. No.: US 2011/0032228 A1
(43) Pub. Date: Feb. 10, 2011

(54) Luminance Adjustment Systems and Methods for Display Units

(75) Inventor: Chun-Hsuan Ho, Taichung (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASIA OPTICAL CO., INC., Taichung (TW)

(21) Appl. No.: 12/849,300

(22) Filed: Aug. 3, 2010

(30) Foreign Application Priority Data
Aug. 6, 2009 (TW) 98126505

(51) Int. Cl. G09G 5/00

(52) U.S. Cl. 345/207

(57) ABSTRACT

Luminance adjustment systems and methods for display units are provided. The system includes a display unit, an image sensor, and a processing unit. The image sensor captures at least one image. The processing unit receives the image from the image sensor, and obtains the image luminance of the image. The processing unit adjusts a display luminance of the display unit according to the image luminance.

### CROSS REFERENCE TO RELATED APPLICATIONS

This Application claims priority of Taiwan Patent Application No. 098126505, filed on Aug. 6, 2009, the entirety of which is incorporated by reference herein.

### BACKGROUND OF THE INVENTION

1. Field of the Invention

The disclosure relates generally to luminance adjustment systems and methods for display units, and, more particularly to systems and methods that consider the luminance of an image captured by an image sensor, and/or the luminance of an environment light source, and accordingly adjust the luminance of a display unit.

2. Description of the Related Art

Machine with display out device (e.g. digital camera or projector) with image sensors such as a charge coupled device (CCD) or complementary metal oxide semiconductor (CMOS) have gradually replaced conventional film cameras. Digital cameras have become a commonplace, due to ease of review and processing of captured images in related devices such as computers.

In image capture devices, such as digital cameras and camcorders, a display unit can be provided to display the image expected to be captured, or playback the captured image. Since a light source may exist in the surrounding environment, the visibility of the image displayed in the display unit can be accordingly influenced. For example, if the luminance of the environment light source is too high, users cannot easily see the image displayed in the display unit.

Currently, some image capture devices can be equipped with a light sensor to detect the luminance of the environment light source, and adjust the display luminance of the display unit according to the luminance of the environment light source. Since the display luminance of the display unit can be adjusted, the visibility of the image displayed in the displayed can be improved. However, in some situations, the luminance adjustment for the display unit based on the luminance of the environment light source may not obtain the best image quality. For example, when a user uses a conventional image capture device to capture a bright scene in a dark environment, since the luminance of the environment light source is low, the display luminance of a display unit thereof is raised, making it more difficult to review the captured scene.

### BRIEF SUMMARY OF THE INVENTION

Luminance adjustment systems and methods for display units are provided.

An embodiment of a luminance adjustment system for display units includes a display unit, a luminance sensor, e.g. light sensor or image sensor, and a processing unit. The image sensor captures at least one image. The processing unit receives the image from the image sensor, and obtains the image luminance of the image. The processing unit adjusts a display luminance of the display unit according to the image luminance.

In an embodiment of a luminance adjustment method for display units, at least one image is captured by an image sensor. Then, a display luminance of a display unit is adjusted according to the image luminance of the captured image.

Luminance adjustment methods for display units may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a luminance adjustment system for display units of the invention;

FIG. 2 is a schematic diagram illustrating another embodiment of a luminance adjustment system for display units of the invention;

FIG. 3 is a flowchart of an embodiment of a luminance adjustment method for display units of the invention; and

FIG. 4 is a flowchart of another embodiment of a luminance adjustment method for display units of the invention.

### DETAILED DESCRIPTION OF THE INVENTION

Luminance adjustment systems and methods for display units are provided.

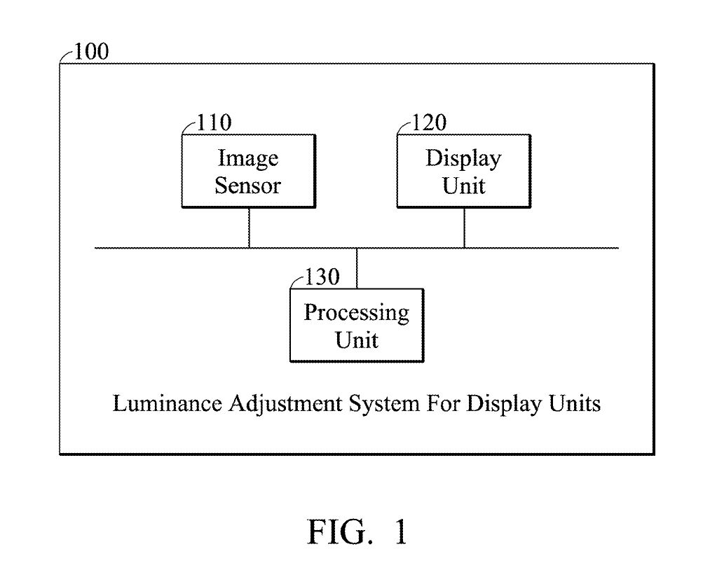

FIG. 1 is a schematic diagram illustrating an embodiment of a luminance adjustment system for display units of the invention. The luminance adjustment system for display units 100 can be used in an electronic device. The electronic device may be a machine with display out device, such as a projector and an image capture device, such as a digital camera and a camcorder.

As shown in FIG. 1, the luminance adjustment system for display units 100 comprises an image sensor 110, a display unit 120, and a processing unit 130. The image sensor 110 may be a CCD or CMOS to capture at least one image. It is noted that, the image sensor can be replaced by any luminance sensor, such as a light sensor. The display unit 120 can display the image captured by the image sensor 110 in real-time, or playback captured images in the image capture device. It is understood that, when the image capture device is in a capture mode, the display unit 120 can display the image currently captured by the image sensor 110. When the image capture device is in a playback mode, the display unit 120 can display the captured images, which can be provided by a storage unit (not shown), such as a hard disk or memory card of the image capture device. The processing unit 130 performs the luminance adjustment method for display units of the invention according to the image captured by the image sensor 110, which will be discussed further in the following paragraphs.

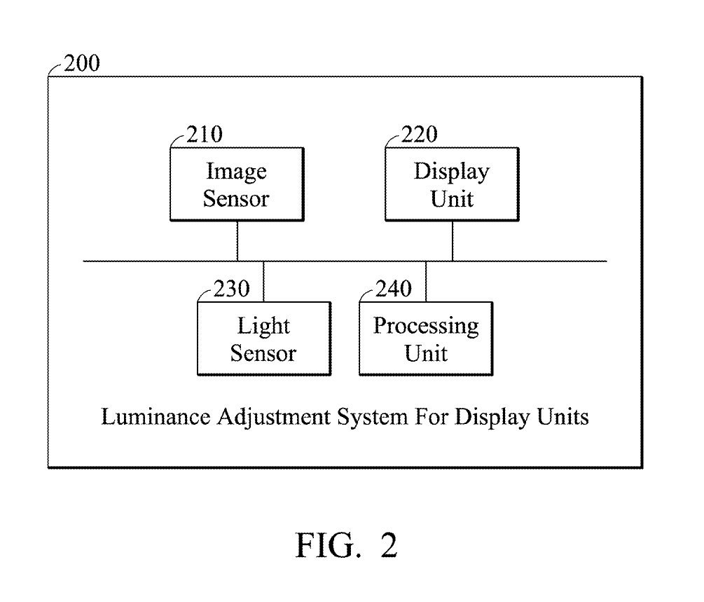

FIG. 2 is a schematic diagram illustrating another embodiment of a luminance adjustment system for display units of the invention. The luminance adjustment system for display units 200 can be used in an electronic device. The electronic device may be a machine with display out device, such as a projector and an image capture device, such as a digital camera and a camcorder.

As shown in FIG. 2, the luminance adjustment system for display units 200 comprises an image sensor 210, a display unit 220, a light sensor 230, and a processing unit 240. The image sensor 210 may be a CCD or CMOS to capture at least one image. The display unit 220 can display the image captured by the image sensor 110 in real-time, or playback captured images in the image capture device. Similarly, when the image capture device is in a capture mode, the display unit 220 can display the image currently captured by the image sensor 110. When the image capture device is in a playback mode, the display unit 220 can display the captured images, which can be provided by a storage unit (not shown), such as a hard disk or memory card of the image capture device. The light sensor 230 can detect an environment luminance of an environment light source surrounding the image capture device. In some embodiments, the light sensor 230 can be set near by the display unit 220, thus to detect the environment luminance of the environment light source projected on the display unit 220. The processing unit 240 performs the luminance adjustment method for display units of the invention according to the image captured by the image sensor 210 and the environment luminance of the environment light source detected by the light sensor 230, which will be discussed further in the following paragraphs.

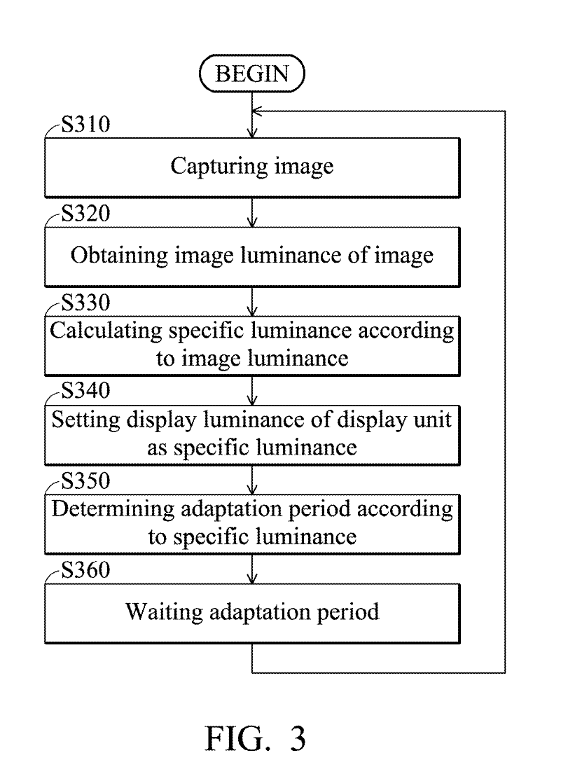

FIG. 3 is a flowchart of an embodiment of a luminance adjustment method for display units of the invention. The embodiment of FIG. 1 is combined with the embodiment of FIG. 3 for discussion.

In step S310, at least one image is captured by the image sensor 110. In step S320, the processing unit 130 receives the image from the image sensor 110, and obtains the image luminance of the image. It is understood that, in some embodiments, the image comprises at least one object, and the image luminance is the luminance of the object. In step S330, the processing unit 130 calculates a specific luminance according to the image luminance of the image. In some embodiments, the image luminance can be input to a function to calculate the specific luminance. In some embodiments, the function may be a Gamma function, a linear function, a finite polynomial function, or an exponential function, for defining the relationships between the image luminance and the display luminance of the display unit.

Then, in step S340, the processing unit 130 sets the display luminance of the display unit as the specific luminance. It is understood that, in some embodiments, the image capture device may have several scene settings, such as a night scene and a snow scene. The processing unit 130 or the storage unit can store a maximum luminance and a minimum luminance for the respective scene setting, wherein a luminance within the maximum luminance and the minimum luminance may be suitable for the scene setting. Consequently, the processing unit 130 can first obtain the current scene setting of the image capture device, and retrieve the maximum luminance and the minimum luminance of the current scene setting. The processing unit 130 can adjust the display luminance of the display unit 120 within the range of the maximum luminance and the minimum luminance. If the specific luminance calculated in step S330 is not within the range, the display luminance of the display unit 120 can be set as the maximum luminance or the minimum luminance of the current scene setting.

Then, in step S350, the processing unit 130 determines an adaptation period according to the calculated specific luminance, and in step S360, waits the adaptation period. It is noted that, in some embodiments, the processing unit 130 does not perform further processing during the adaptation period. After the adaptation period, the procedure returns to step S310. It is understood that, for the naked eye, different adaptation periods may be available for different luminance. Consequently, by determining an appropriate adaptation period, and whether to re-determine the display luminance of the display unit 120 after the adaptation period, user comfort is achieved when viewing the display unit. In some embodiments, the adaptation period can be determined according to the difference between the current display luminance of the display unit 120 and the calculated specific luminance.

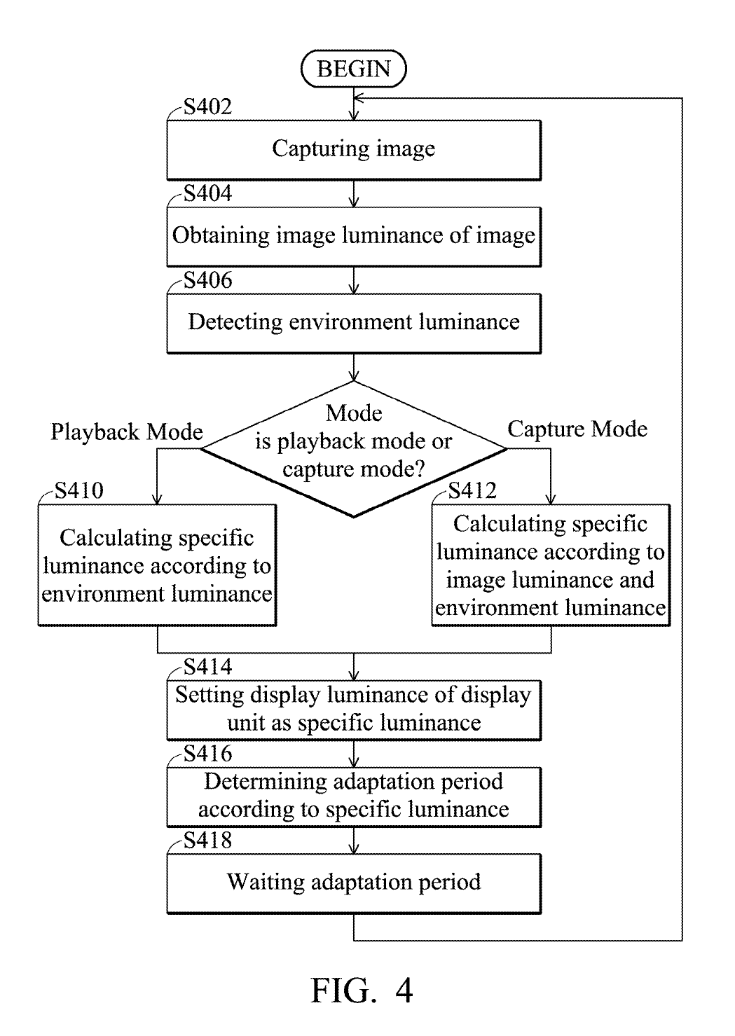

FIG. 4 is a flowchart of another embodiment of a luminance adjustment method for display units of the invention. The embodiment of FIG. 2 is combined with the embodiment of FIG. 4 for discussion.

In step S402, at least one image is captured by the image sensor 210. In step S404, the processing unit 240 receives the image from the image sensor 210, and obtains the image luminance of the image. In step S406, an environment luminance of an environment light source surrounding the display unit 220 is detected by the light sensor 230. In step S408, the processing unit 240 obtains a current mode of the image capture device, and determines whether the current mode of the image capture device is a playback mode or a capture mode. When the current mode of the image capture device is the playback mode, in step S410, the processing unit 240 ignores the image luminance, and calculates a specific luminance according to the environment luminance of the environment light source detected by the light sensor 230. Similarly, in some embodiments, the environment luminance can be input to a function to calculate the specific luminance. In some embodiments, the function may be a Gamma function, a linear function, a finite polynomial function, or an exponential function, for defining the relationships between the environment luminance and the display luminance of the display unit. When the current mode of the image capture device is the capture mode, in step S412, the processing unit 240 calculates a specific luminance according to the image luminance of the image, and the environment luminance of the environment light source. In some embodiments, a summation luminance can be calculated according to the image luminance of the image, and the environment luminance of the environment light source, and the summation luminance can be input to a function to calculate the specific luminance In some embodiments, the function may be a Gamma function, a linear function, a finite polynomial function, or an exponential function, for defining the relationships between the summation luminance and the display luminance of the display unit.

Then, in step S414, the processing unit 240 sets the display luminance of the display unit as the specific luminance Similarly, in some embodiments, the image capture device may have several scene settings, such as a night scene and a snow scene. The processing unit 240 or the storage unit can store a maximum luminance and a minimum luminance for the respective scene setting, wherein a luminance within the maximum luminance and the minimum luminance may be suitable for the scene setting. Consequently, the processing unit 240 can first obtain the current scene setting of the image capture device, and retrieve the maximum luminance and the minimum luminance of the current scene setting. The processing unit 240 can adjust the display luminance of the display unit 220 within the range of the maximum luminance and the minimum luminance. If the specific luminance calculated in step S410 or S412 is not within the range, the display luminance of the display unit 220 can be set as the maximum luminance or the minimum luminance of the current scene setting.

Then, in step S416, the processing unit 240 determines an adaptation period according to the calculated specific luminance, and in step S418, waits the adaptation period. Similarly, in some embodiments, the processing unit 130 does not perform further processing during the adaptation period. After the adaptation period, the procedure returns to step S402. Similarly, in some embodiments, the adaptation period can be determined according to the difference between the current display luminance of the display unit 220 and the calculated specific luminance.

Therefore, the luminance adjustment systems and methods for display units can consider the luminance of the image captured by the image sensor, and/or the luminance of the environment light source, and accordingly adjust the luminance of the display unit.

Luminance adjustment systems and methods for display units, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A luminance adjustment system for display units for use in an electronic device, comprising:
a display unit;
an image sensor capturing at least one image; and
a processing unit coupled to the image sensor and the display unit, receiving the image from the image sensor, obtaining an image luminance of the image, and adjusting a display luminance of the display unit according to the image luminance

2. The system of claim 1, further comprising a light sensor detecting an environment luminance of an environment light source near to and surrounding the display unit, wherein the processing unit further adjusts the display luminance of the display unit according to the environment luminance.

3. The system of claim 2, wherein the processing unit further obtains a mode of the electronic device, and when the mode of the electronic device is a capture mode, the processing unit adjusts the display luminance of the display unit according to the image luminance and the environment luminance.

4. The system of claim 3, wherein when the mode of the electronic device is a playback mode, the processing unit ignores the image luminance, and adjusts the display luminance of the display unit according to the environment luminance.

5. The system of claim 1, wherein the processing unit further obtains a scene setting of the electronic device, and retrieves a maximum luminance and a minimum luminance of the scene setting, wherein the display luminance of the display unit is adjusted within the maximum luminance and the minimum luminance.

6. The system of claim 2, wherein the processing unit calculates a summation luminance according to the image luminance and the environment luminance, inputs the summation luminance to a function to calculate a specific luminance, and sets the display luminance of the display unit as the specific luminance, wherein the function defines the relationship between the summation luminance and the display luminance of the display unit.

7. The system of claim 6, wherein the function comprises a Gamma function, a linear function, a finite polynomial function, or an exponential function.

8. The system of claim 2, wherein the processing unit further determines an adaptation period according to a specific luminance calculated based on the image luminance and the environment luminance, and re-adjusts the display luminance of the display unit after the adaptation period.

9. The system of claim 8, wherein the adaptation period is determined according to a difference between a current display luminance of the display unit and the specific luminance.

10. The system of claim 2, wherein the light sensor is set near by the display unit for detecting the environment luminance projected on the display unit.

11. A luminance adjustment method for display units for use in an electronic device, comprising:
capturing at least one image via an image sensor; and
adjusting a display luminance of a display unit according to an image luminance of the image.

12. The method of claim 11, further comprising:
detecting an environment luminance of an environment light source near to and surrounding the display unit via a light sensor; and
adjusting the display luminance of the display unit according to the environment luminance.

13. The method of claim 12, further comprising:
obtaining a mode of the electronic device; and
when the mode of the electronic device is a capture mode, adjusting the display luminance of the display unit according to the image luminance and the environment luminance.

14. The method of claim 13, further comprising when the mode of the electronic device is a playback mode, ignoring the image luminance, and adjusting the display luminance of the display unit according to the environment luminance.

15. The method of claim 11, further comprising:
obtaining a scene setting of the electronic device; and
retrieving a maximum luminance and a minimum luminance of the scene setting,
wherein the display luminance of the display unit is adjusted within the maximum luminance and the minimum luminance.

16. The method of claim 12, further comprising:
calculating a summation luminance according to the image luminance and the environment luminance;
inputting the summation luminance to a function to calculate a specific luminance; and
setting the display luminance of the display unit as the specific luminance,
wherein the function defines the relationship between the summation luminance and the display luminance of the display unit.

17. The method of claim 16, wherein the function comprises a Gamma function, a linear function, a finite polynomial function, or an exponential function.

18. The method of claim 13, further comprising:
determining an adaptation period according to a specific luminance calculated based on the image luminance and the environment luminance; and
re-adjusting the display luminance of the display unit after the adaptation period.

19. The method of claim 18, wherein the adaptation period is determined according to a difference between a current display luminance of the display unit and the specific luminance.

20. The method of claim 13, wherein the light sensor is set near by the display unit for detecting the environment luminance projected on the display unit.
